(19) United States
(12) Patent Application Publication
(10) Pub. No.: US 2025/0356379 A1
(43) Pub. Date: Nov. 20, 2025

(54) SYSTEM AND METHOD FOR CALL CENTER NATURAL LANGUAGE PROCESSING

(71) Applicant: Royal Bank of Canada, Toronto (CA)

(72) Inventors: David CURRY, Austin, TX (US); Megha JAIN, Austin, TX (US); David YU, Austin, TX (US); Jacy LEGAULT, Austin, TX (US); Asif SHEIKH, Toronto (CA)

(21) Appl. No.: 19/208,168

(22) Filed: May 14, 2025

Related U.S. Application Data
(60) Provisional application No. 63/647,345, filed on May 14, 2024.

(51) Int. Cl. G06Q 30/0201; G06F 16/3329; G06F 16/34; G10L 15/02; G10L 15/26; H04M 3/51

(52) U.S. Cl. CPC G06Q 30/0201; G06F 16/33295; G06F 16/345; G10L 15/02; G10L 15/26; H04M 3/51

(57) ABSTRACT

Disclosed herein are systems and methods for natural language processing for a call center. Audio data are received for at least a portion of a call between a call center representative and a call center user. An audio-to-text transcription of the call is generated upon processing the audio data. At least one generative model is applied to the transcription to obtain: a text summary of the call; answers to pre-defined questions relating to the customer and/or the call; and at least one assessment score of the call. In some cases, an electronic signal to trigger remedial action may be generated.

### CROSS-REFERENCE TO RELATED APPLICATION

This application claims the benefit of and priority to U.S. provisional patent application No. 63/647,345 filed May 14, 2024, the entire content of which is herein incorporated by reference.

### FIELD

This disclosure relates to call centers, and more specifically relates to natural language processing of call center data.

### BACKGROUND

Call centers serve as vital hubs for customer interaction, providing essential support and assistance across various industries. However, the efficient processing of call center data presents significant challenges due to the sheer volume, variety, and velocity of data generated during customer interactions. There are myriad challenges to analyzing and understanding call center data, leading to inefficiencies, data silos, suboptimal service delivery, lost business, or the like. Therefore, improvements are desired.

### SUMMARY

In accordance with an aspect, there is provided a computer-implemented method for natural language processing for a call center. The method includes receiving audio data for at least a portion of a call between a call center representative and a call center user; generating an audio-to-text transcription of the call upon processing the audio data; and applying at least one generative model to the transcription to obtain: a text summary of the call; answers to pre-defined questions relating to the customer and/or the call; and at least one assessment score of the call.

In such method, such applying at least one generative model to the transcription may include providing the pre-defined questions to the at least one generative model.

In such method, such applying at least one generative model to the transcription may include providing the transcript to the at least one generative model to generate the text summary and the answers; and providing at least one of the text summary and the answers to the at least one generative model to generate the at least one assessment score.

In such method, the same generative model may be used to generate the text summary, the answers, and the at least one assessment score.

In such method, the at least one generative model may include a large language model.

In such method, an output of the at least one generative model may be applied as an input to the at least one generative model in subsequent processing.

Such method may further include upon the applying, generating an electronic signal to trigger remedial action.

In such method, such generating the electronic signal may be during a call in progress.

In such method, the remedial action may include prompting the call center representative to follow a particular script portion.

In such method, the remedial action may include routing the call to another person.

In such method, such generating the audio-to-text transcription may include generating speaker attribution metadata.

In such method, such generating the audio-to-text transcription may include generating time stamp metadata.

In such method, the at least one assessment score may be indicative of a quality of a business opportunity associated with the call center user.

In such method, the at least one assessment score may include a plurality of assessment scores.

In such method, the at least one assessment score may include at least one of a lead score, a financial readiness score, and an interest level score.

In accordance with another aspect, there is provided a computer-implemented system for natural language processing for a call center. The system includes a processing subsystem that includes one or more processors and one or more memories coupled with the one or more processors. The processing subsystem is configured to cause the system to: receive audio data for at least a portion of a call between a call center representative and a call center user; generate an audio-to-text transcription of the call upon processing the audio data; apply at least one generative artificial intelligence model to the transcription to obtain: a text summary of the call; answers to pre-defined questions relating to the customer and/or the call; and at least one assessment score of the call.

Such system may be interconnected by way of a network with a plurality of call centers, and the audio data may be among data received by way of the network from the plurality of call centers.

In such system, the same generative model may be used to generate the text summary, the answers, and the at least one assessment score.

In such system, an output of the at least one generative model may be applied as an input to the at least one generative model in subsequent processing.

In accordance with yet another aspect, there is provided a non-transitory computer-readable medium or media having stored thereon machine interpretable instructions which, when executed by a processing system, cause the processing system to perform a method for natural language processing for a call center. The method includes: receiving audio data for at least a portion of a call between a call center representative and a call center user; generating an audio-to-text transcription of the call upon processing the audio data; and applying at least one generative model to the transcription to obtain: a text summary of the call; answers to pre-defined questions relating to the customer and/or the call; and at least one assessment score of the call.

Many further features and combinations thereof concerning embodiments described herein will appear to those skilled in the art following a reading of the instant disclosure.

### DESCRIPTION OF THE FIGURES

In the figures,

FIG. 1 is a network diagram of a network environment for a call center data processing system, in accordance with an embodiment;

FIG. 2 is a schematic diagram of a call center data processing system, in accordance with an embodiment;

FIG. 3 is a schematic diagram of an inference engine of a call center data processing system, in accordance with an embodiment;

FIG. 4 is a workflow diagram of a call center data processing system, in accordance with an embodiment;

FIG. 5 depicts transcript generation at a call center data processing system, in accordance with an embodiment;

FIG. 6 depicts a generative model prompt used at a call center data processing system, in accordance with an embodiment;

FIG. 7 is a flowchart showing example operation of the call center data processing system of FIG. 1, in accordance with an embodiment; and

FIG. 8 is a schematic diagram of a computing device, in accordance with an embodiment.

### DETAILED DESCRIPTION

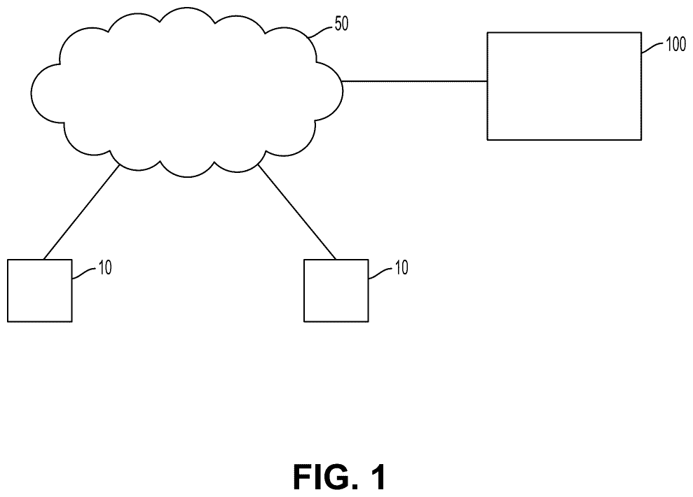

FIG. 1 is a diagram depicting a network environment for gathering call center data and applying natural language processing to such data, in accordance with an embodiment. This network environment includes one or more call centers 10. Each call center 10 may perform a variety of customer interaction functions including engaging in telephonic communication (or other type communication) with customers (including potential customers) for the purpose of marketing, sales, supporting, providing a concierge service, or the like.

A call center 10 may be staffed by a plurality of customer service representatives. A call center 10 may be configured to enable such customer service representatives to communicate with customers via calls over POTS (plain old telephone service), VoIP (Voice over Internet Protocol), or other telephony or videotelephony service. A communication channel may be established between a customer service representative and a customer via network 50 or another communication network.

Within the depicted network environment, a call center data processing system 100 may be provided in accordance with aspects of the present disclosure. Call center data processing system 100 may be referred to herein as processing system 100 for ease of reference.

Call center data processing system 100 is interconnected with one or more call centers 10 by network 50, and processes data originating at a call center 10. Such data may include, for example, audio data of call conversations with customers.

Embodiments of processing system 100 may produce various technical effects and provide various technical advantages.

In some embodiments, processing system 100 may process a large volume of audio data originating at a call center, and perform natural language processing to transform such audio data from unstructured data to structured data.

In some embodiments, processing system 100 may transform audio data into a form that is readily indexable, searchable, and/or analyzable.

In some embodiments, processing system 100 may transform audio data into text data that can be stored using reduced compute resources. In some embodiments, such text data may be further condensed into summaries, extracts, digests, or the like, resulting in further resource savings. Conveniently, such summaries, extracts, digests allow for more efficient interpretation, e.g., by a human operator or by an automated system.

In some embodiments, audio data may be processed to generate actionable and/or predictive analytics and/or insights. Conveniently, in some embodiments, such analytics and/or insights may be used to improve performance of a business' agents or representatives. In some embodiments, such analytics and/or insights may be used to improve business outcomes with customers.

Network 50 may include a packet-switched network portion, a circuit-switched network portion, or a combination thereof. Network 50 may include wired links, wireless links such as radio-frequency links or satellite links, or a combination thereof. Network 50 may include wired access points and wireless access points. Portions of network 50 could be, for example, an IPV4, IPV6, X.25, IPX or similar network. Portions of network 50 could be, for example, a GSM, GPRS, 3G, LTE, 5G, or similar wireless networks. Network 50 may include or be connected to the Internet. When network 50 is a public network such as the public Internet, it may be secured as a virtual private network.

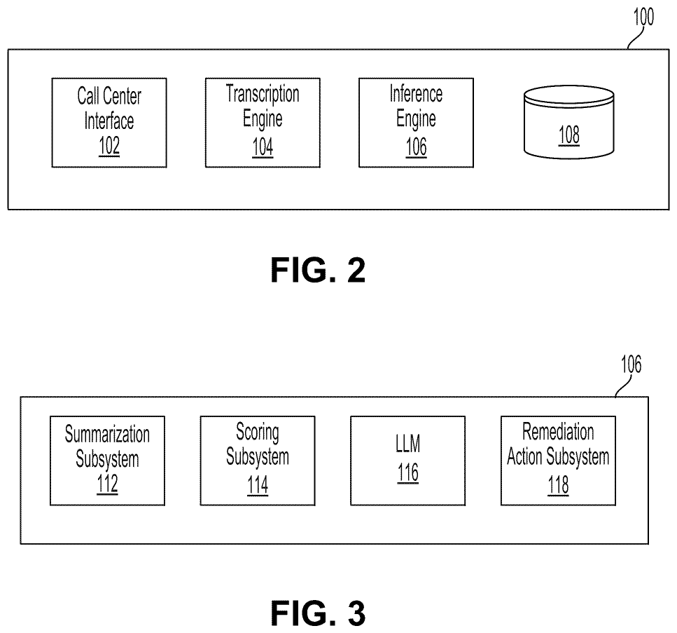

FIG. 2 is a schematic diagram of call center data processing system 100, in accordance with an embodiment. As depicted, processing system 100 includes a call center interface 102, a transcription engine 104, an inference engine 106, and an electronic datastore 108.

Call center interface 102 is configured for electronic communication with one or more call centers 10. For example, call center interface 102 may receive data signals encoding audio data from a call center 10. The audio data may encode at least a portion of a call between a call center representative and a call center user. In some embodiments, the call may be a multi-party call with three or more users. Call center interface 102 may decompress, decrypt, decode, de-noise, transcode, or otherwise pre-process the audio data to make it suitable for transcription generation. The audio data (e.g., in WAV, AIFF, MP3, or other format) is provided to transcription engine 104.

In some embodiments, call center interface 102 receives audio data from a plurality of call centers 10, and data signals encode an identifier of the source of the audio data such as an identifier of a particular call center 10.

Transcription engine 104 is configured to perform natural language processing on audio data. For example, transcription engine 104 processes audio data to perform audio-to-text transcription of a call (or portion thereof). In some embodiment, transcription engine 104 implements a machine learning model trained to perform audio-to-text transcription. In the depicted embodiment, this machine learning model is a Whisper model distributed by OpenAl. In other embodiments, other models, algorithms, or tools for audio-to-text transcription may be used.

Transcription engine 104 is configured to perform audio-to-text transcription in English or another desired language. In some embodiments, transcription engine 104 is configured to perform audio-to-text transcription on multiple languages, and automatically detect the language(s) used in a call conversation.

Transcription engine 104 generates a data structure with data defining a text transcription of a call (or portion thereof). Transcription engine 104 receives an input defining such data structure.

In some embodiments, transcription engine 104 performs automatic speaker attribution, and the generated data structure includes identifiers of the speakers (e.g., speaker name, employee identifier, customer identifier, etc.), e.g., in association with each utterance or other text portion, and the associated timestamps. Transcription engine 104 can generate the timestamp by estimating the start time of each utterance based on a system clock. In some embodiments, transcription engine 104 performs emotion or mood detection and the data structure is generated to include data defining the outputs of such detection, e.g., to identify that a customer is impatient, upset, eager, etc., and their associated timestamps. In some embodiments, the data structure includes data defining such and other timestamps, e.g., associated with utterances, detection of certain emotions or moods, when participants join or leave a call, and/or other call events.

In some embodiments, transcription engine 104 generates a data structure with data defining a text transcription and associated metadata such as detected emotions or moods, labeling of speaker identities, or the like.

As noted, the data structure of the desired output may be defined in an input to transcription engine 104. This input may define the contents or format of the desired output. In some embodiments, the input may include a JSON file or the like that defines the desired output. In some embodiments, the input may define a desired output that provides a transcript in two or more formats. For example, the transcript may be requested in both a first format that is a verbatim transcription of a call, e.g., without metadata, and a second format with the transcription of the call along with speaker attribution and timestamps.

In one embodiment, the second format may be as follows:
[identity of speaker 1] [estimated start time]: [text of speech]
[identity of speaker 2] [estimated start time]: [text of speech].

Inference engine 106 is configured to process transcription data to transform such data into other forms of data, and generate analytics and/or insights. Inference engine 106 includes one or more generative models configured to generate various requested outputs. In some embodiments, inference engine 106 implements an interface, e.g., an application programming interface (API), to utilize one or more generative models separate from processing system 100. For example, inference engine 106 may access such a generative model by way of an API via network 50.

In some embodiments, the generative models may include a generative artificial intelligence (AI) model. In some embodiments, the generative models may include a large language model (LLM).

In some embodiments, a generative model may utilize hyperparameters (e.g., temperature, maximum output token limit, etc.), as may be stored in electronic datastore 108.

In some embodiments, inference engine 106 is a multi-modal engine that processes multi-modal input. For example, in such embodiments, inference engine 106 may receive and process additional information about a customer (e.g., historical interactions, purchase history, website behavioral history, etc.) in addition to transcription data for a given call.

FIG. 3 is a schematic diagram of inference engine 106, in accordance with an embodiment. In the depicted embodiment, inference engine 106 includes a summarization subsystem 112, a scoring subsystem 114, an LLM 116, and an remedial action subsystem 118.

Summarization subsystem 112 is configured to process transcription data to generate summaries, extracts, distillations, or the like. Summarization subsystem 112 provides the transcription data to LLM 116 along with a suitable prompt requesting LLM 116 to generate a desired output. For example, summarization subsystem 112 may cooperate with LLM 116 to generate a summary of a call. The summary may be used to facilitate quick reference and understanding, e.g., by a call center administrator or manager of the business.

Scoring subsystem 114 is configured to generate one or more scores that evaluate a call based on associated one or more pre-determined criteria. Scoring subsystem 114 provides transcription data (or a distillation or other derivative) to LLM 116 along with a suitable prompt requesting LLM 116 to generate one or more desired scores.

The scores may be generated to be within a pre-defined range and may be numerical scores (e.g., 0-100) or textual labels (e.g., low/medium/high). For example, the scores may include one or more of an interest level score, a financial readiness score, an overall lead score, a customer satisfaction score, a customer frustration score, or the like.

In some examples, a score may reflect potential business outcomes. In some examples, a score may reflect areas of high performance or low performance by call center representatives. In some embodiments, the scores may be used to identify high-value leads, allowing resources to be allocated to such leads, which may in turn improve conversion rates. In some embodiments, the scores may be used to identify areas for improvement in customer service and/or communication strategies.

In some embodiments, scoring subsystem 114 outputs the scores in a pre-defined format such as JSON format, XML, or the like.

LLM 116 is a large language model suitable for generating the outputs requested by summarization subsystem 112 and scoring subsystem 114. In the depicted embodiment, LLM 116 is the LLamMA (Large Language Model Meta AI) 2 model distributed by Meta AI. In some embodiments, various other LLMs or other models may be used. In some embodiments, multiple LLMS or other models may be used, e.g., a suitable combination of one or more of LLamMA 3, Mistral models, or the like. In some embodiments, models may each be dedicated to servicing one of summarization subsystem 112 or scoring subsystem 114.

Remedial action subsystem 118 is configured to identify and remediate customer and process issues. For example, transcription data outputted by transcription engine may be processed to automate remedial or other actions to improve an outcome with a particular customer. In some embodiments, the transcription data may be combined with insights and/or analytics generated by inference engine 106 to identify issues. In this way, processing system 100 “watches” over a call center and can automatically trigger a remedial action to address customer problems or process problems or otherwise provide an automated intervention. For example, remedial action subsystem 118 may generate an electronic signal to trigger the remedial action.

In some embodiments, remedial action subsystem 118 triggers a remedial action in real-time (i.e., during the course of a call or promptly after the call). For example, based on processing of partial transcription of a call in progress, remedial action subsystem 118 may prompt a call center representative to follow a specific script portion. In another example, remedial action subsystem 118 may route the call to another company employee such as a real estate agent or a supervisor if particular expertise or customer handling is required. In another example, remedial action subsystem may route the call to a specific person, e.g., a specific real estate agent. In another example, inference engine 106 may detect a script adherence error on the part of the call center representative, and remedial action subsystem 118 may use this insight to trigger automatically a review for coaching of the call center representative as well as customer remediation.

Each of call center interface 102, transcription engine 104, and inference engine 106 may be implemented using a suitable combination of software and hardware components. Such software components may be implemented in whole or in part using conventional programming languages such as Java, J #, C, C++, C #, Perl, Python, Visual Basic, Ruby, Scala, etc. Such software components of processing system 100 may be in the form of one or more executable programs, scripts, routines, statically/dynamically linkable libraries, servlets, or the like.

Electronic datastore 108 may implement a conventional relational, object-oriented, or document-oriented database, such as Microsoft SQL Server, Oracle, DB2, Sybase, Pervasive, MongoDB, NoSQL, etc. Electronic datastore 108 may store data (including intermediate data) generated at processing system 100 (e.g., transcripts, summaries, analytics, or the like).

In some embodiments, electronic datastore 108 may store the following data, as may be outputted by inference engine 106:
(a) Call metadata: time of the call, length of call, call id, customer id, representative id;
(b) Call transcription;
(c) LLM outputs: detailed call summary, various scores; and
(d) Model metadata: transcription model version, LLM version, prompt versions.

### EXAMPLE APPLICATION

The functionality and operation of call center data processing system 100 is further described with reference to an example call center of a business that helps customers find, buy, finance, and/or sell homes. In this example, the call center makes thousands of calls to customers every day, with the goal of transforming customer intent (e.g., as identified via a website) into sales transactions (e.g., real estate transactions or mortgage transactions). These calls generate a vast amount of data that is difficult to analyze at such scale.

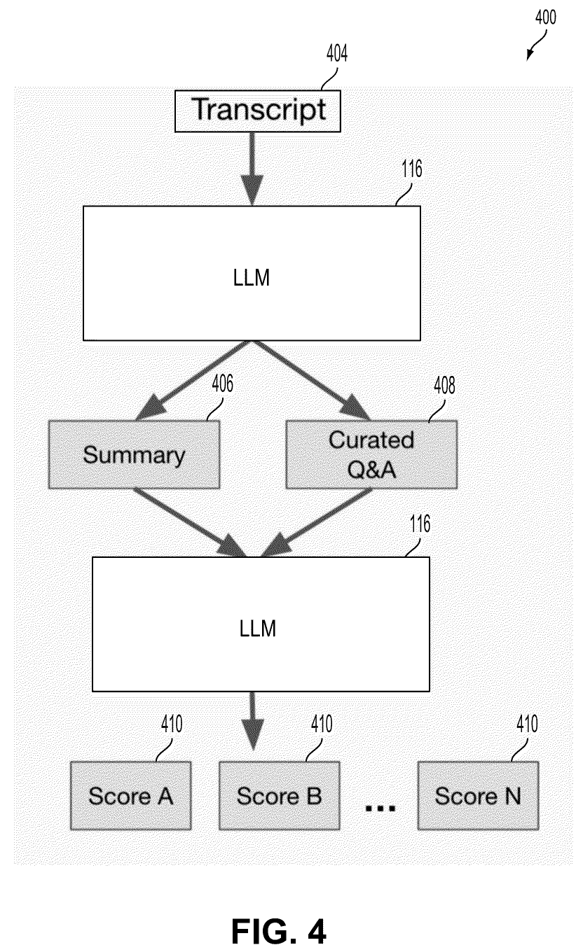

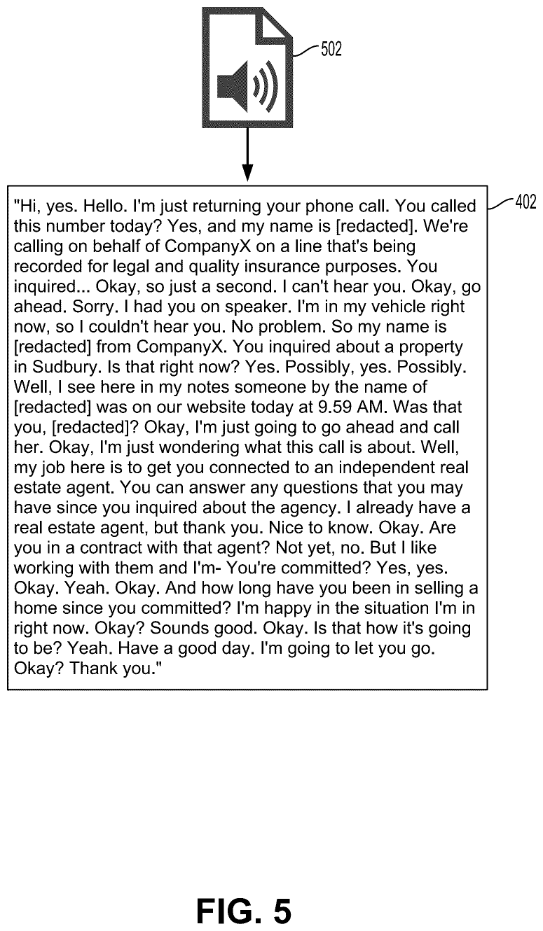

FIG. 4 depicts a workflow diagram showing example workflow 400 performed at processing system 100, in accordance with an embodiment. In this workflow, transcription engine 104 receives audio data of at least a portion of a call and generates a transcript. For example, in the depicted embodiment, transcription engine 104 may receive audio data in the form of an MP3 file 502 (FIG. 5) and utilize a machine learning model to generate an audio-to-text transcription 404 of the call.

Audio-to-text transcription 404 is used by summarization subsystem 112 to generate a text summary of the call and to generate answers to a set of pre-defined questions.

Summarization subsystem 112 generates a text summary by providing audio-to-text transcription 404 to LLM 116 with a prompt defining the desired output. In response to this prompt, LLM 116 generates a summary 406.

Summarization subsystem 112 generates answers to a set of pre-defined questions by providing audio-to-text transcription 404 to LLM 116 with a prompt defining the desired output. In response to this prompt, LLM 116 generates a curated set of question and answers (Q&A) 408. In some embodiments, the prompt includes the set of pre-defined questions. In some embodiments, the prompt includes additional information such as context or a requested format for the answers.

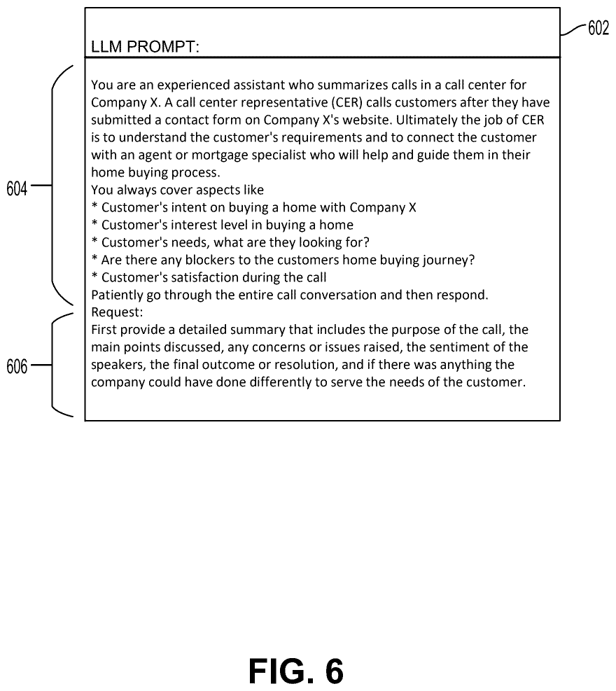

FIG. 6 depicts an example prompt 602 for generating summary 406, in accordance with an embodiment. Prompt 602 includes a context portion 604 that provides LLM 116 with contextual information for generating the desired text summary, and a request portion 606 that defines the requested output.

A prompt for generating curated Q&A 408 may similarly include a context portion and a request portion. In some embodiments, the context portion may be similar to the context portion of FIG. 6. The request portion asks multiple questions with clear intent and sets the stage for clear and concise answers. “Yes” or “No” type questions are preferred as they lead to more accurate and stable responses.

Example questions include:
Was the customer willing to get connected with a CompanyX real estate agent (where CompanyX is the example name of a company operating a call center 10)?
How serious was the customer about buying a home?
Is the customer likely to buy a home with a CompanyX real estate agent?
Did the customer already have their own agent and not willing to work with a CompanyX agent?
What is the customer's home buying timeline now, this year, no timeline?
Was there any indication of mortgage pre-approval or pre-qualified?

Scoring subsystem 114 generates N scores 410 that evaluate a call based on N associated pre-determined criteria, i.e., score A, score B . . . score N. Scoring subsystem 114 generates scores 410 by providing summary 406 and curated Q&A 408 to LLM 116 along with a suitable prompt requesting the scores.

Of note, in this embodiment, the same LLM 116 is used to generate summary 406, curated Q&A 408, and scores 410. However, in other embodiments, multiple LLMs or other generative models may be used.

Also of note, scores 410 are not generated by providing LLM 116 with transcript 404. Rather, LLM 116 is provided with its own outputted summary 406 and curated Q&A 408. In other words, an output of LLM 116 is used as input of LLM 116. Conveniently, this allows LLM 116 to generate scores 410 using more relevant information than the original transcription data.

In the depicted embodiment, scores 410 may include a lead score, a financial readiness score, and an interest level score.

Each of the prompts used by scoring subsystem 114 for these scores includes:
Context and outline of the company's call center process;
Instructions for JSON formatted output;
Score definition (title and possible values); and
Guidance on what is relevant to focus on in the calls.

For example, to generate a lead score, LLM 116 is prompted to generate a score based on the following criteria:
“high”: if the customer appears to be interested in the company's services, is ready to buy, and is not blocked financially or otherwise;
“low”: if the customer is not interested in the company's services, is not ready to buy, or blocked financially or otherwise;
“avg”: if the customer shows moderate interest in the company's services and is not clearly blocked, but also not clearly ready; and. “unsure”: there was not enough information in the call to assign any other score.

For example, to generate a financial readiness score, LLM 116 is prompted to assign a score based on the following criteria:
“ready”: if the customer has stated they are pre-approved, prequalified, is a cash buyer, or is a homeowner;
“not-blocked”: if the customer has been pre-approved or prequalified for a mortgage that is in progress, but is not yet approved, or if the customer feels confident in ability to get approved for a mortgage' and
“unsure”: if any of the following are true:
   Finance status was not discussed in the call.
   There was not enough information in the call to assign any other score.
   Customer has not yet started on the financing process.

For example, to generate an interest level score, LLM 116 is prompted to assign a score based on the following criteria:
“high”:
   The customer is very interested in buying a home and wants to get started with the home buying process immediately.
   If the customer wanted to connect with a CompanyX agent, then that indicates high interest.
   Willingness to work with a CompanyX agent.
“low”:
   If the customer is hesitant to work with CompanyX or a CompanyX agent.
   Wanting to work with a listing agent.
   If the customer is already working with an agent and does not want a new agent.
“avg”: Customer's interest level is in between high and low criteria and represents a customer on the fence about working with the company;
“unsure”:
   There was not enough information in the call to assign any other score.
   Call was too short to assign any other interest level.
   If you're not confident about customer's interest level.

In some embodiments, processing system 100 is used to generate outputs usable to improve operational efficiency.

In some embodiments, processing system 100 may automatically identify required follow-up actions. For example, if it is determined upon processing a transcript that the customer expressed interest in obtaining a mortgage, processing system 100 may flag an action that a mortgage specialist should reach out to that customer. Such follow-up actions may be stored in association with a data record of the call, e.g., in electronic datastore 108.

In some embodiments, processing system 100 may automatically detect when a new person has joined the call, e.g., a real estate agent joining a call in progress between a customer and a customer service representative. The successful joining of such new person may be included as metadata in the generated transcription with an associated time stamp. The identifier of the particular real estate agent joining the call can also be stored as part of the metadata of the transcription. In such embodiments, processing system 100 may evaluate the performance of the new person in addition to the performance of the customer service representative. As will be appreciated, the ability of processing system 100 to distinguish between different speakers is used to evaluate such speakers separately. Further, the length of the call for each of the participants may be extracted and stored.

In some embodiments, processing system 100 processes timestamp metadata associated with particular utterances (or other transcript portions) to determine, for example, whether a customer service representative rushed through a question, or to detect that there was a pause in answering a question.

In some embodiments, processing system 100 is used to generate outputs to assist compliance with consumer interaction standards. For example, in such embodiments, processing system 100 generates outputs indicating whether customer interactions meet the standards set by regulatory bodies like the Consumer Financial Protection Bureau (CFPB). In an example, compliance with a standard may be assessed by detecting whether a call center representative has adhered to particular portions of a call script, e.g., particular moments in a scripting decision tree. An example of such a moment is when deciding which mortgage service to pitch. Assessment of compliance with the standard may include assessment of whether the pitch was made under the correct conditions. A record of the assessment may be stored or transmitted electronically for further action.

In some embodiments, processing system 100 is used to maintain alignment with Basel II A-IRB Requirements. For example, in such embodiments, processing system 100 may aid in maintaining high-quality customer interactions, which is a critical component of the Advanced Internal Ratings-Based (A-IRB) approach under Basel II, particularly in managing credit risk and operational risk.

In some embodiments, processing system 100 receives and processes data for a plurality of call centers, e.g., interconnected with processing system 100 by way of network 50. In such embodiments, processing system 100 may receive data including audio data of calls from such plurality of call centers.

Although embodiments of processing system 100 are described with reference to customer touchpoints involving voice communication, in other embodiments, processing system 100 may be adapted to operate with other types of language-based communication such as text-based chat.

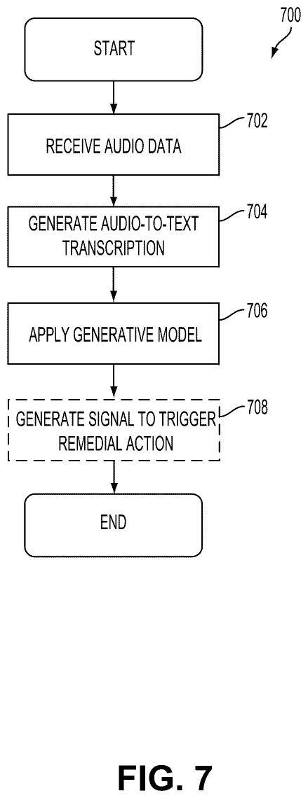

The operation of processing system 100 is further described with reference to the flowchart depicted in FIG. 7. Assessment system 100 performs the example operations depicted at blocks 700 and onward, in accordance with an embodiment.

At block 702, processing system 100 receives audio data for at least a portion of a call between a call center representative and a call center user. The audio data may be received in the form of an MP3 file such as file 502 (FIG. 5) or another suitable form. In some embodiments, the audio data are received for a recording of a completed call. In some embodiments, the audio data are received in the form of a data stream, e.g., in the case of a call in progress.

At block 704, processing system 100 generates an audio-to-text transcription of the call upon processing the audio data. The transcription may, for example, be audio-to-text transcription 404 (FIG. 4).

At block 706, processing system 100 applies at least one generative artificial intelligence model to the transcription to obtain: a text summary of the call; answers to pre-defined questions relating to the customer and/or the call; and at least one assessment score of the call. The at least one generative model may include, for example, LLM 116.

Optionally, at block 708, upon applying the at least one generative artificial intelligence model, processing system 100 generates an electronic signal to trigger remedial action. In some embodiments, the remedial action includes prompting the call center representative to follow a particular script portion. In some embodiments, the remedial action includes routing the call to another person. In some embodiments, the remedial action is triggered during a call in progress.

It should be understood that steps of one or more of the blocks depicted in FIG. 7 may be performed in a different sequence or in an interleaved or iterative manner. Further, variations of the steps, omission or substitution of various steps, or additional steps may be considered.

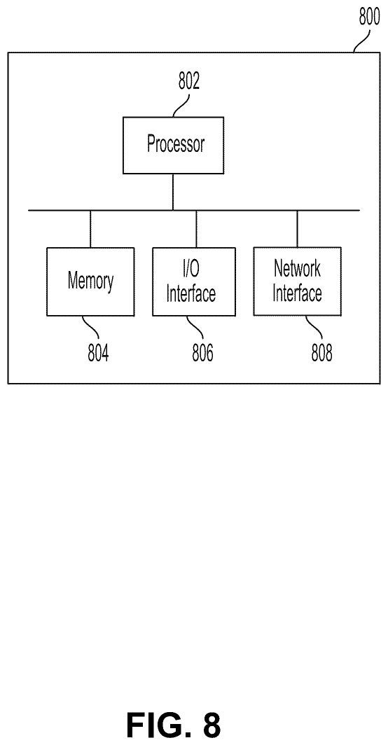

FIG. 8 is a schematic diagram of a computing device 800 suitable for implementing call center data processing system 100, in accordance with an embodiment. As depicted, computing device 800 includes a processing subsystem with one or more processors 802 and memory 804. Computing device 800 also includes one or more I/O interfaces 806, and, optionally, one or more network interfaces 808.

Each processor 802 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 804 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 804 may store code executable at processor 802, which causes request processing system 100 to function in manners disclosed herein.

Each I/O interface 806 enables computing device 800 to interconnect with one or more input devices, such as a keyboard, mouse, camera, touch screen and a microphone, or with one or more output devices such as a display screen and a speaker.

Each network interface 808 enables computing device 800 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

Each computing devices may be connected in various ways including directly coupled, indirectly coupled via a network, and distributed over a wide geographic area and connected via a network (which may be referred to as “cloud computing”).

For example, and without limitation, each computing device 800 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A computer-implemented method for natural language processing for a call center, the method comprising:
receiving audio data for at least a portion of a call between a call center representative and a call center user;
generating an audio-to-text transcription of the call upon processing the audio data; and
applying at least one generative model to the transcription to obtain:
a text summary of the call;
answers to pre-defined questions relating to the customer and/or the call; and
at least one assessment score of the call.

2. The computer-implemented method of claim 1, wherein said applying at least one generative model to the transcription includes:
providing the pre-defined questions to the at least one generative model.

3. The computer-implemented method of claim 1, wherein said applying at least one generative model to the transcription includes:
providing the transcript to the at least one generative model to generate the text summary and the answers; and
providing at least one of the text summary and the answers to the at least one generative model to generate the at least one assessment score.

4. The computer-implemented method of claim 2, wherein the same generative model is used to generate the text summary, the answers, and the at least one assessment score.

5. The computer-implemented method of claim 1, wherein said at least one generative model includes a large language model.

6. The computer-implemented method of claim 1, wherein an output of the at least one generative model is applied as an input to the at least one generative model in subsequent processing.

7. The computer-implemented method of claim 1, further comprising:
upon said applying, generating an electronic signal to trigger remedial action.

8. The computer-implemented method of claim 7, wherein said generating said electronic signal is during a call in progress.

9. The computer-implemented method of claim 7, wherein said remedial action includes prompting the call center representative to follow a particular script portion.

10. The computer-implemented method of claim 7, wherein said remedial action includes routing the call to another person.

11. The computer-implemented method of claim 1, wherein said generating the audio-to-text transcription includes generating speaker attribution metadata.

12. The computer-implemented method of claim 1, wherein said generating the audio-to-text transcription includes generating time stamp metadata.

13. The computer-implemented method of claim 1, wherein the at least one assessment score is indicative of a quality of a business opportunity associated with the call center user.

14. The computer-implemented method of claim 1, wherein the at least one assessment score includes a plurality of assessment scores.

15. The computer-implemented method of claim 1, wherein the at least one assessment score includes at least one of a lead score, a financial readiness score, and an interest level score.

16. A computer-implemented system for natural language processing for a call center, the system comprising:
a processing subsystem that includes one or more processors and one or more memories coupled with the one or more processors, the processing subsystem configured to cause the system to:
receive audio data for at least a portion of a call between a call center representative and a call center user;
generate an audio-to-text transcription of the call upon processing the audio data;
apply at least one generative artificial intelligence model to the transcription to obtain:
a text summary of the call;
answers to pre-defined questions relating to the customer and/or the call; and
at least one assessment score of the call.

17. The computer-implemented system of claim 16, wherein the system is interconnected by way of a network with a plurality of call centers, and said audio data are among data received by way of the network from said plurality of call centers.

18. The computer-implemented system of claim 16, wherein the same generative model is used to generate the text summary, the answers, and the at least one assessment score.

19. The computer-implemented system of claim 16, wherein an output of the at least one generative model is applied as an input to the at least one generative model in subsequent processing.

20. A non-transitory computer-readable medium or media having stored thereon machine interpretable instructions which, when executed by a processing system, cause the processing system to perform a method for natural language processing for a call center, the method comprising:
receiving audio data for at least a portion of a call between a call center representative and a call center user;
generating an audio-to-text transcription of the call upon processing the audio data; and
applying at least one generative model to the transcription to obtain:
a text summary of the call;
answers to pre-defined questions relating to the customer and/or the call; and
at least one assessment score of the call.
